(19) United States
(12) Patent Application Publication
(10) Pub. No.: US 2025/0042439 A1
(43) Pub. Date: Feb. 6, 2025

(54) AUTONOMOUS VEHICLE AND A METHOD OF CONTROLLING THE SAME

(71) Applicants: HYUNDAI MOTOR COMPANY, Seoul (KR); KIA CORPORATION, Seoul (KR)

(72) Inventor: Jun Hyung Song, Gwangmyeong-si (KR)

(73) Assignees: HYUNDAI MOTOR COMPANY, Seoul (KR); KIA CORPORATION, Seoul (KR)

(21) Appl. No.: 18/522,875

(22) Filed: Nov. 29, 2023

(30) Foreign Application Priority Data
Jul. 31, 2023 (KR) 10-2023-0099604

(51) Int. Cl. B60W 60/00; B60R 21/013; B60R 22/48; B60W 30/09

(52) U.S. Cl. CPC B60W 60/0016; B60R 21/013; B60R 22/48; B60W 30/09; B60W 2710/18

(57) ABSTRACT

A method of controlling an autonomous vehicle including a processor configured to control a sensor includes: detecting, under control of the processor, an object located in front of the autonomous vehicle based on driving information sensed by the sensor; and determining whether an occupant in the autonomous vehicle wears a seat belt when the detected object enters a preset safety distance range. Based on determining whether the occupant wears the seat belt when the detected object enters the preset safety distance range, a control operation to variably activate a safe mode is performed.

### CROSS-REFERENCE TO RELATED APPLICATION

This application claims the benefit of and priority to Korean Patent Application No. 10-2023-0099604, filed on Jul. 31, 2023, the entire contents of which are incorporated herein by reference.

### FIELD

The present disclosure relates to an autonomous vehicle and a method of controlling the same, and more particularly, to an autonomous vehicle capable of controlling variable warning and collision risk variable braking of a Forward Collision-Avoidance Assist (FCA) function based on whether a seat belt is worn, and a method of controlling the same.

### BACKGROUND

The statements in this section merely provide background information related to the present disclosure and may not constitute prior art.

A seat belt of a vehicle is an example of a safety device capable of preventing serious injuries by elastically restraining a body of an occupant when sudden impact due to a minor collision or a crash accident is encountered during driving.

In a normal driving environment, a probability of injury to an occupant is low even when a seat belt is not worn until collision occurs, and thus some occupants do not wear seat belts.

For example, when a vehicle is subject to emergency braking by FCA while an occupant is not wearing a seat belt during driving and, there is a problem in that, as a speed of the vehicle rapidly decreases, the occupant not wearing the seat belt leans forward due to acceleration of the vehicle and collides with an interior part of the vehicle, resulting in injury.

### SUMMARY

The present disclosure is directed to an autonomous vehicle and a method of controlling the same that substantially obviate one or more problems due to limitations and disadvantages of the related art.

An object of the present disclosure is to provide an autonomous vehicle capable of controlling variable warning and collision risk variable braking of an FCA function based on whether a seat belt is worn, and a method of controlling the same.

The technical challenges sought to be achieved in the present disclosure are not limited to the technical challenges mentioned above, and other technical challenges not mentioned here should be clearly understood by those having ordinary skill in the art in the technical field to which the present disclosure pertains from the description below.

Additional advantages, objects, and features, of the disclosure are set forth in part in the following description and in part should become apparent to those having ordinary skill in the art upon examination of the following or may be learned from practice of the present disclosure. The objects and other advantages of the disclosure may be realized and attained by the structures particularly pointed out in the written description and claims thereof as well as the appended drawings.

To achieve these objects and other advantages and in accordance with the purpose of the present disclosure, as embodied and broadly described herein, a method of controlling an autonomous vehicle including a processor configured to control a sensor comprises: detecting, by the processor, an object located in front of the autonomous vehicle based on driving information sensed by the sensor. The method also includes determining, by the processor, whether an occupant of the autonomous vehicle wears a seat belt when the detected object enters a preset safety distance range; and performing, by the controller, a control operation to variably activate a safe mode based on a determination result of whether the occupant wears the seat belt when the detected object enters the preset safety distance range.

In at least one embodiment of the present disclosure, performing the control operation may comprises operating a collision risk signal faster than a collision risk signal in a normal mode upon determining that the occupant is not wearing the seat belt under control of the processor.

In at least one embodiment of the present disclosure, the collision risk signal may include a collision risk early warning, a collision risk early braking, or any combination thereof. In another embodiment, performing the control operation further comprises operating the collision risk early warning faster than collision risk warning in the normal mode upon determining that the occupant is not wearing the seat belt under control of the processor.

In at least one embodiment of the present disclosure, performing the control operation further comprises operating the collision risk early braking faster than collision risk braking in the normal mode upon determining that the occupant is not wearing the seat belt.

In at least one embodiment of the present disclosure, the method further comprises: detecting, by the processor, whether the safe mode is activated may detected upon determining that the occupant is not wearing the seat belt; and determining, by the processor, a driving risk degree when the safe mode is activated.

In at least one embodiment of the present disclosure, the method further comprises: determining, by the processor, the vehicle is a driving risk state when the driving risk degree is outside a preset driving risk range; and re-warning about not wearing the seat belt under control of the processor.

In at least one embodiment of the present disclosure, the method further comprises: determining, by the processor, that the vehicle is in a driving risk state when the driving risk degree is outside a preset driving risk range; and performing, by the processor, a control to operate an airbag in an airbag operation condition more relaxed than a previous airbag operation condition.

In another aspect of the present disclosure, a non-transitory computer-readable recording medium stores a program for executing the method of controlling the autonomous vehicle. In particular, the program directs a processor of the autonomous vehicle to perform acts of: i) detecting an object located in front of the autonomous vehicle based on driving information sensed by at least one sensor of the autonomous vehicle; ii) determining whether an occupant of the autonomous vehicle wears a seat belt when the detected object enters a preset safety distance range; and iii) performing a control to variably activate a safe mode based on a determination result of whether the occupant wears the seat belt when the detected object enters the preset safety distance range.

In another aspect of the present disclosure, an autonomous vehicle comprises a sensor, and a processor configured to control the sensor. In particular, the processor is configured to: detect an object located in front of the autonomous vehicle based on driving information sensed by the sensor, determine whether an occupant in the autonomous vehicle wears a seat belt when the detected object enters a preset safety distance range, and perform a control operation to variably activate a safe mode based on a determination result of whether the occupant wears the seat belt when the detected object enters the preset safety distance range.

The processor may be further configured to perform a control operation to operate a collision risk signal faster than a collision risk signal in a normal mode upon determining that the occupant is not wearing the seat belt.

The collision risk signal may include at least one of a collision risk early warning or a collision risk early braking, and the process may be further configured to perform a control operation to operate the collision risk early warning faster than collision risk warning in the normal mode upon determining that the occupant is not wearing the seat belt.

The processor may be further configured to perform a control operation to operate the collision risk early braking faster than collision risk braking in the normal mode upon determining that the occupant is not wearing the seat belt.

The processor may be further configured to detect whether the safe mode is activated upon determining that the occupant is not wearing the seat belt, and perform a control operation to determine a driving risk degree when the safe mode is activated.

The processor may be further configured to determine that the vehicle is in a driving risk state when the driving risk degree is outside a preset driving risk range, and perform a control operation to re-warn about not wearing the seat belt.

The processor may be further configured to: determine that the vehicle is in a driving risk state when the driving risk degree is outside a preset driving risk range, and operate an airbag in an airbag operation condition more relaxed than a previous airbag operation condition.

It should be understood that both the foregoing general description and the following detailed description of the present disclosure are exemplary and explanatory and are intended to provide further explanation of the present disclosure.

### BRIEF DESCRIPTION OF THE DRAWINGS

The accompanying drawings are included to provide a further understanding of the present disclosure and are incorporated in and constitute a part of the present disclosure. The accompanying drawings illustrate embodiment(s) of the present disclosure and together with the description and serve to explain the principle of the present disclosure. In the drawings:

FIG. 1 is a block diagram for describing an autonomous vehicle according to an embodiment of the present disclosure;

FIG. 2 is a flowchart for describing a method of controlling the autonomous vehicle according to an embodiment of the present disclosure; and

FIG. 3 is a diagram for describing a control operation of the autonomous vehicle according to an embodiment of the present disclosure.

### DETAILED DESCRIPTION

Hereinafter, embodiments of the present disclosure are described in detail with reference to the attached drawings so that those having ordinary skill in the art in the technical field to which the present disclosure pertains may easily implement the embodiments. However, the present disclosure may be implemented in several different forms and is not limited to the embodiments described herein. To clearly describe the present disclosure in the drawings, parts unrelated to the description are omitted, and similar reference numerals are assigned to similar parts throughout the present disclosure.

Throughout the present disclosure, when a part “includes” a certain element, this means that other elements may be further included, rather than excluding other elements, unless stated otherwise. In addition, parts indicated with the same reference numerals throughout the present disclosure mean the same elements.

In addition, the terms “unit” or “control unit” included in names such as a vehicle control unit (VCU) are only widely used terms for naming a controller that controls a specific function of a vehicle, and the terms do not mean a generic functional unit. For example, each control unit may include a communication device configured to communicate with another control device or sensor to control a function assigned thereto, a memory configured to store an operating system or logic command and input/output information, and one or more processors configured to perform determination, calculation, decision, etc. necessary for controlling the function assigned thereto. When a component, device, unit, element, or the like of the present disclosure is described as having a purpose or performing an operation, function, or the like, the component, device, unit, element, or the like should be considered herein as being “configured to” meet that purpose or to perform that operation or function. Each component, device, unit, element, and the like may separately embody or be included with a processor and a memory, such as a non-transitory computer readable media, as part of the apparatus.

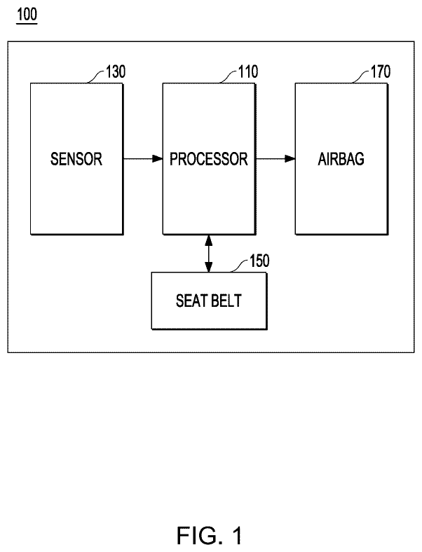

FIG. 1 is a block diagram for describing an autonomous vehicle according to an embodiment of the present disclosure.

Referring to FIG. 1, an autonomous vehicle 100 according to an embodiment of the present disclosure may include a processor 110 and a sensor 130.

The sensor 130 may be a front detection sensor 130 disposed at a front of the autonomous vehicle 100, a vehicle, etc. In one embodiment, the sensor 130 may include a radar, a camera, a LiDAR, etc.

At least one radar may be mounted on the autonomous vehicle 100. The radar may measure a relative speed and a relative distance with respect to a recognized object in conjunction with a wheel speed sensor mounted on the autonomous vehicle 100.

At least one camera may be mounted on the autonomous vehicle 100. The camera may photograph an obstacle around the autonomous vehicle 100 and a condition of the obstacle, and output image data based on the photographed information.

At least one LiDAR may be mounted in or on the autonomous vehicle 100. The LiDAR may radiate a laser pulse to an object. When the object is within a measurement range of the LiDAR, the laser pulse is reflected by the object and returns to the LiDAR. The LiDAR measures a time it takes to receive the retuned laser pulse and tracks its angles from the moment of radiating the laser pulse and outputs LiDAR data including at least one of a distance to the object, a direction of the object, or a speed of the object. Here, the object may refer to an obstacle, a person, a thing, etc. present outside the autonomous vehicle 100.

The processor 110 may detect an object located in front of the autonomous vehicle 100 based on driving information sensed by the sensor 130, determine whether an occupant in the autonomous vehicle 100 wears a seat belt 150 when the detected object enters a preset distance range (hereinafter, referred to as ‘a preset safety distance range’) around the vehicle 100, and perform a control operation to variably activate a safe mode based on a determination result. The safe mode may include a FCA function of the vehicle, which is an autonomous driving function, a Lane Departure Warning (LDW) function, a Lane Keeping Assist (LKA) device, a Blind-spot Collision Avoidance Assist (BCA) function, or any combination thereof.

Upon determining that the seat belt 150 of the occupant is not worn, the processor 110 may control a collision risk signal to operate faster than the collision risk signal in a normal mode. There may be one or more occupants in the vehicle. The occupants may include a driver or a passenger.

Here, the collision risk signal may include collision risk early warning and collision risk early braking.

Upon determining that the seat belt 150 of the occupant is not worn, the processor 110 may perform a control operation so that the collision risk early warning operates faster than collision risk warning in the normal mode.

Upon determining that the seat belt 150 of the occupant is not worn, the processor 110 may perform a control operation so that the collision risk early braking operates faster than collision risk braking in the normal mode.

In addition, upon determining that the seat belt 150 of the occupant is not worn, the processor 110 may detect whether the safe mode is activated, and perform a control operation to determine a driving risk degree when the safe mode is activated.

When the driving risk degree is outside a preset driving risk range, the processor 110 may determine that the vehicle is in a driving risk state, and perform a control operation to reissue a warning for not wearing the seat belt 150. Upon determining that the vehicle is in the driving risk state, the processor 110 may issue at least one warning for not wearing the seat belt 150. In other words, the processor 110 may reissue a warning for not wearing the seat belt 150.

When the driving risk degree is outside the preset driving risk range, the processor 110 may determine that the vehicle is in the driving risk state, and perform a control operation so that an airbag 170 is operated in an operation condition more relaxed than a previous operation condition of the airbag 170.

For example, when the airbag 170 is operated in an existing operation condition of 30 km or more, the processor 110 may operate the airbag 170 in a relaxed operation condition of 20 km or more, thereby more safely protecting an occupant not wearing the seat belt 150.

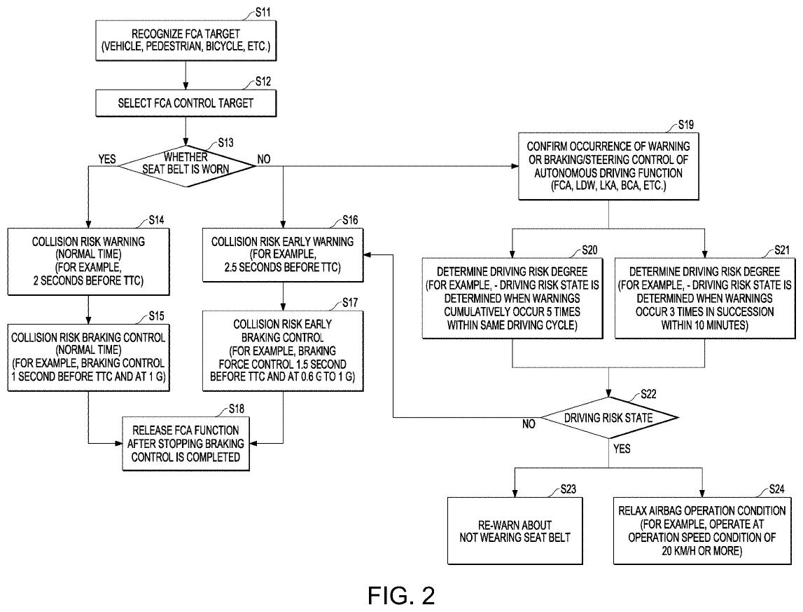

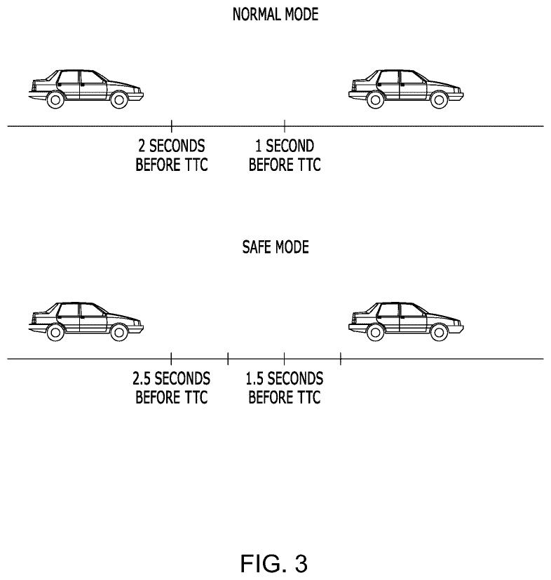

FIG. 2 is a flowchart for describing a method of controlling the autonomous vehicle according to an embodiment of the present disclosure. FIG. 3 is a diagram for describing a control operation of the autonomous vehicle 100 according to an embodiment of the present disclosure.

Referring to FIG. 2, the processor 110 may detect an object located in front of the autonomous vehicle 100 based on driving information sensed by the sensor 130.

In operation S11, the processor 110 may recognize an FCA target among objects located in front of the autonomous vehicle 100 using the sensor 130. Objects or FCA targets may include vehicles, pedestrians, and bicycles.

The processor 110 may determine whether the detected object or the recognized FCA target enters the preset safety distance range. For example, when the recognized FCA target enters the preset safety distance range, the processor 110 may select the recognized FCA target as an FCA control target in an operation 512.

Then, in operation 513, the processor 110 may determine whether the seat belt 150 of the occupant is worn.

The processor 110 may perform a control operation to variably activate the safe mode based on a determination result.

In one embodiment, upon determining that the occupant is wearing the seat belt 150, the processor 110 may operate in the normal mode.

As shown in FIG. 3, in the normal mode, the collision risk warning may occur approximately 2 seconds before time-to-collision (TTC) in an operation S14. Thereafter, in the normal mode, collision risk braking control may be performed approximately 1 second before TTC and at an acceleration of 1 g (an operation S15).

Thereafter, in an operation S18, the processor 110 may perform a control operation so that an operation in the normal mode is released after stopping braking control is completed.

In contrast, upon determining that the seat belt 150 of the occupants is not worn, the processor 110 may perform a control operation so that the collision risk signal operates faster than the collision risk signal in the normal mode. Here, the collision risk signal may include a collision risk early warning, a collision risk early braking or the combination of the collision risk early warning and the collision risk early braking.

In an operation S16, upon determining that the occupant is not wearing the seat belt 150, the processor 110 may perform a control operation so that the collision risk early warning operates faster than the collision risk warning in the normal mode. As shown in FIG. 3, the processor 110 may perform a control operation so that the collision risk early warning operates approximately 2.5 seconds before TTC.

Thereafter, in an operation S17, upon determining that the occupant is not wearing the seat belt 150, the processor 110 may perform a control operation so that the collision risk early braking operates faster than the collision risk braking in the normal mode. As shown in FIG. 3, the processor 110 may perform a control operation so that the collision risk early braking operates approximately 1.5 seconds before TTC and in an acceleration range of 0.6 g to 1 g.

Thereafter, in an operation S18, the processor 110 may perform a control operation so that the FCA function is released or deactivated after the stopping braking control is completed.

Further, in an operation S19, upon determining that the seat belt 150 of the occupant is not worn, the processor 110 may detect whether the safe mode operates (S19). Here, the safe mode may be activated when occurrence of a warning or braking/steering control of an autonomous driving function (FCA, LDW, LKA, BCA, etc.) is confirmed.

In operations S20 and S21, the processor 110 may perform a control operation so that the safe mode determines the driving risk degree.

When warnings cumulatively occur 5 times within the same driving cycle (in an operation S20), or when warnings occur 3 times in succession within 10 minutes (in an operation S21), the processor 110 may determine that the driving risk range is outside the preset driving risk range.

For example, when warnings cumulatively occur 5 times within the same driving cycle, the processor 110 may determine that the vehicle is in the driving risk state. Alternatively, when warnings occur three times in succession within 10 minutes, the processor 110 may determine that the vehicle is in the driving risk state. The present disclosure is not limited thereto and may vary depending on the driving environment.

In an operation S22, when the driving risk degree is outside the preset driving risk range, the processor 110 may determine that the vehicle is in the driving risk state.

Upon determining that the vehicle is not in the driving risk state (NO in the operation S22), the processor 110 may perform a control operation so that the collision risk early warning operates faster than the collision risk warning in the normal mode. For example, as shown in FIG. 3, the processor 110 may perform a control operation so that the collision risk early warning operates approximately 2.5 seconds before TTC.

Upon determining that the vehicle is in the driving risk state (YES in the operation S22), the processor 110 may perform a control operation to reissue a warning for not wearing the seat belt 150. In other words, the processor 110 may re-warn about not wearing the seat belt 150 (S22).

In an operation S24, the processor 110 may determine that the vehicle is in the driving risk state, and perform a control operation so that the airbag 170 operates in an operation condition more relaxed than the previous operation condition.

For example, when the airbag 170 is operated in an existing operation condition of 30 km or more, the processor 110 of the present disclosure may operate the airbag 170 in a relaxed operation condition of 20 km or more, thereby more safely protecting an occupant not wearing the seat belt 150.

As described above, the autonomous vehicle and the method of controlling the same in the present disclosure may allow a driver to recognize a dangerous situation early by issuing an early warning in variable warning point logic so that an occupant not wearing a seat belt may prepare for emergency braking in a situation where emergency braking of the FCA function operates, thereby reducing a possibility that the occupant not wearing the seat belt may be injured due to collision with the interior of the vehicle as a result of rapid deceleration of the vehicle.

In addition, the autonomous vehicle and the method of controlling the same in the present disclosure may minimize an impact on an occupant by reducing braking force together with early operation of braking control of the FCA function when an occupant in the vehicle is not wearing a seat belt.

In addition, the autonomous vehicle and the method of controlling the same in the present disclosure may induce an occupant to wear a seat belt for safety by cumulatively calculating the number of warnings of an autonomous driving function for a driver driving habit or an inattention state to determine a driving risk degree, and re-warning the occupant for not wearing the seat belt when the vehicle is determined to be in the driving risk state.

In addition, the autonomous vehicle and the method of controlling the same in the present disclosure may reduce occurrence of injuries to occupants in the event of collision by relaxing the airbag operation condition in preparation for occurrence of a vehicle collision upon determining that the vehicle is in the driving risk state.

The autonomous vehicle and the method of controlling the same in the present disclosure configured as described above have an effect of allowing a driver to recognize a dangerous situation early by issuing an early warning in variable warning point logic so that an occupant not wearing a seat belt may prepare for emergency braking in a situation where emergency braking of the FCA function operates, thereby reducing a possibility that the occupant not wearing the seat belt may be injured due to collision with the interior of the vehicle as a result of rapid deceleration of the vehicle.

In addition, the autonomous vehicle and the method of controlling the same in the present disclosure have an effect of being able to minimize an impact on an occupant by reducing braking force together with early operation of braking control of the FCA function when the occupant of the vehicle is not wearing a seat belt.

In addition, the autonomous vehicle and the method of controlling the same in the present disclosure have an effect of being able to induce an occupant to wear a seat belt for safety by cumulatively calculating the number of warnings of an autonomous driving function for a driver driving habit or an inattention state to determine a driving risk degree, and re-warning the occupant for not wearing the seat belt when the vehicle is determined to be in the driving risk state.

In addition, the autonomous vehicle and the method of controlling the same in the present disclosure have an effect of being able to reduce occurrence of injuries to occupants in the event of collision by relaxing the airbag operation condition in preparation for occurrence of a vehicle collision upon determining that the vehicle is in the driving risk state.

The effects obtainable from the present disclosure are not limited to the effects mentioned above, and other effects not mentioned here may be clearly understood by those having ordinary skill in the art in the technical field to which the present disclosure pertains from the above description.

The present disclosure described above may be implemented as computer-readable code on a medium in which a program is recorded. The computer-readable medium includes all types of recording devices in which data readable by a computer system is stored. Examples of the computer-readable medium include a hard disk drive (HDD), a solid state drive (SSD), a silicon disk drive (SDD), a ROM, a RAM, a CD-ROM, a magnetic tape, a floppy disk, an optical data storage device, etc.

Accordingly, the above detailed description should not be construed as restrictive in all respects and should be considered illustrative. The scope of the present disclosure needs to be determined by reasonable interpretation of the attached claims, and all changes within the equivalent scope of the present disclosure are included in the scope of the present disclosure.

What is claimed is:

1. A method for controlling an autonomous vehicle comprising a processor configured to control a sensor, the method comprising:
detecting, by the processor, an object located in front of the autonomous vehicle based on driving information sensed by the sensor;
determining, by the processor, whether an occupant of the autonomous vehicle wears a seat belt when the detected object enters a preset safety distance range; and
performing, by the processor, a control to variably activate a safe mode based on a determination result of whether the occupant wears the seat belt when the detected object enters the preset safety distance range.

2. The method according to claim 1, wherein performing the control comprising operating a collision risk signal faster than a collision risk signal in a normal mode upon determining that the occupant is not wearing the seat belt.

3. The method according to claim 2, wherein the collision risk signal comprises at least one of a collision risk early warning or a collision risk early braking, and wherein performing the control further comprises operating the collision risk early warning faster than a collision risk warning in the normal mode upon determining that the occupant is not wearing the seat belt.

4. The method according to claim 3, wherein performing the control further comprises operating the collision risk early braking faster than a collision risk braking in the normal mode upon determining that the occupant is not wearing the seat belt.

5. The method according to claim 1, further comprising:
detecting, by the processor, whether the safe mode is activated upon determining that the occupant is not wearing the seat belt; and
determining, by the processor, a driving risk degree when the safe mode is activated.

6. The method according to claim 5, further comprising:
determining, by the processor, that the vehicle is in a driving risk state when the driving risk degree is outside a preset driving risk range; and
re-warning about not wearing the seat belt under control of the processor.

7. The method according to claim 5, further comprising:
determining, by the processor, that the vehicle is in a driving risk state when the driving risk degree is outside a preset driving risk range; and
performing, by the processor, a control to operate an airbag in an airbag operation condition more relaxed than a previous airbag operation condition.

8. A non-transitory computer-readable recording medium having a program recorded thereon, the program to direct a processor of an autonomous vehicle to perform acts of:
detecting an object located in front of the autonomous vehicle based on driving information sensed by at least one sensor of the autonomous vehicle;
determining whether an occupant of the autonomous vehicle wears a seat belt when the detected object enters a preset safety distance range; and
performing a control to variably activate a safe mode based on a determination result of whether the occupant wears the seat belt when the detected object enters the preset safety distance range.

9. An autonomous vehicle comprising:
a sensor; and
a processor configured to control the sensor, wherein the processor is configured to:
detect an object located in front of the autonomous vehicle based on driving information sensed by the sensor;
determine whether an occupant in the autonomous vehicle wears a seat belt when the detected object enters a preset safety distance range; and
perform a control operation to variably activate a safe mode based on a determination result of whether the occupant wears the seat belt when the detected object enters the preset safety distance range.

10. The autonomous vehicle according to claim 9, wherein the processor is further configured to perform a control operation to operate a collision risk signal faster than a collision risk signal in a normal mode upon determining that the occupant is not wearing the seat belt.

11. The autonomous vehicle according to claim 10, wherein:
the collision risk signal comprises at least one of a collision risk early warning or a collision risk early braking; and
the process is further configured to perform a control operation to operate the collision risk early warning faster than collision risk warning in the normal mode upon determining that the occupant is not wearing the seat belt.

12. The autonomous vehicle according to claim 11, wherein the processor is further configured to perform a control operation to operate the collision risk early braking faster than collision risk braking in the normal mode upon determining that the occupant is not wearing the seat belt.

13. The autonomous vehicle according to claim 9, wherein the processor is further configured to:
detect whether the safe mode is activated upon determining that the occupant is not wearing the seat belt; and
perform a control operation to determine a driving risk degree when the safe mode is activated.

14. The autonomous vehicle according to claim 13, wherein the processor is further configured to:
determine that the vehicle is in a driving risk state when the driving risk degree is outside a preset driving risk range; and
perform a control operation to re-warn about not wearing the seat belt.

15. The autonomous vehicle according to claim 13, wherein the processor is further configured to:
determine that the vehicle is in a driving risk state when the driving risk degree is outside a preset driving risk range; and
operate an airbag in an airbag operation condition more relaxed than a previous airbag operation condition.
